(19) United States
(12) Patent Application Publication
(10) Pub. No.: US 2024/0320489 A1
(43) Pub. Date: Sep. 26, 2024

(54) METHODS AND DEVICES RELATED TO EXPERIENCE-APPROPRIATE EXTENDED REALITY NOTIFICATIONS

(71) Applicant: Telefonaktiebolaget LM Ericsson (publ), Stockholm (SE)

(72) Inventors: Konstantinos VANDIKAS, Solna (SE); Marin ORLIC, BROMMA (SE); Kristijonas CYRAS, San Jose, CA (US); Alexandros NIKOU, Danderyd (SE); Alessandro PREVITI, STOCKHOLM (SE)

(73) Assignee: Telefonaktiebolaget LM Ericsson (publ), Stockholm (SE)

(21) Appl. No.: 18/691,568

(22) PCT Filed: Sep. 13, 2021
(86) PCT No.: PCT/SE2021/050870

§ 371 Date: Mar. 13, 2024

(51) Int. Cl. G06N 3/08; G06F 3/01

(52) U.S. Cl. CPC G06N 3/08; G06F 3/015; G06F 2203/011

(57) ABSTRACT

A computer-implemented method (500) for determining, using a machine learning (ML) model, extended reality (XR) notification types for delivering notification of an event to a user is provided. The method includes receiving user information, wherein the user information includes user characteristics and relationships data; receiving event information, wherein the event information includes event type data; determining, using a machine learning (ML) model, recommended notification types for delivering notification of the event to the user and, for each recommended notification type, predicted emotional state information including a predicted emotional state of the user and a rating; receiving local preferences information for the user, wherein the local preferences information includes one or more of local preferences for different notification types, different event types, and different wanted emotional states; selecting the notification type for delivering the notification of the event to the user by comparing, for each recommended notification type, the predicted emotional state information and the local preferences information; and delivering the notification of the event to the user using the selected notification type.

### TECHNICAL FIELD

This disclosure relates to delivering notifications of events to users in extended reality environments and, in particular, to methods and devices for determining, using machine learning (ML) models, extended reality (XR) notification types for delivering notifications of events to users.

### BACKGROUND

### Extended Reality

Extended reality (XR) uses computing technology to create simulated environments (a.k.a., XR environments or XR scenes). XR is an umbrella term encompassing virtual reality (VR) and real-and-virtual combined realities, such as augmented reality (AR) and mixed reality (MR). Accordingly, an XR system can provide a wide variety and vast number of levels in the reality-virtuality continuum of the perceived environment, bringing AR, VR, MR and other types of environments (e.g., mediated reality) under one term.

### Augmented Reality (AR)

AR systems augment the real world and its physical objects by overlaying virtual content. This virtual content is often produced digitally and incorporates sound, graphics, and video. For instance, a shopper wearing AR glasses while shopping in a supermarket might see nutritional information for each object as they place the object in their shopping carpet. The glasses augment reality with additional information.

### Virtual Reality (VR)

VR systems use digital technology to create an entirely simulated environment. Unlike AR, which augments reality, VR is intended to immerse users inside an entirely simulated experience. In a fully VR experience, all visuals and sounds are produced digitally and does not have any input from the user's actual physical environment. For instance, VR is increasingly integrated into manufacturing, whereby trainees practice building machinery before starting on the line. A VR system is disclosed in US 20130117377 A1.

### Mixed Reality (MR)

MR combines elements of both AR and VR. In the same vein as AR, MR environments overlay digital effects on top of the user's physical environment. However, MR integrates additional, richer information about the user's physical environment such as depth, dimensionality, and surface textures. In MR environments, the user experience therefore more closely resembles the real world. To concretize this, consider two users hitting a MR tennis ball in on a real-world tennis court. MR will incorporate information about the hardness of the surface (grass versus clay), the direction and force the racket struck the ball, and the players' height.

### XR User Device

An XR user device is an interface for the user to perceive both virtual and/or real content in the context of extended reality. An XR user device has one or more sensory actuators, where each sensory actuator is operable to produce one or more sensory stimulations. An example of a sensory actuator is a display that produces a visual stimulation for the user. A display of an XR user device may be used to display both the environment (real or virtual) and virtual content together (e.g., video see-through), or overlay virtual content through a semi-transparent display (e.g., optical see-through). The XR user device may also have one or more sensors for acquiring information about the user's environment (e.g., a camera, inertial sensors, etc.). Other examples of a sensory actuator include a haptic feedback device, a speaker that produces an aural stimulation for the user, an olfactory device for producing smells, etc.

XR environments are poised to radically change the way that we work and interact with our environment. One application for XR is to produce notifications for different events that are of interest to different people in a personalized context. There are a broad spectrum of different notifications including, for example, notifications about changes in the weather, alarm clocks, meeting reminders, and advertisements.

In this context, more conventional systems, such as smartphones, provide rudimentary mechanisms for notifications which are limited to visual (on screen notifications), audial and vibrations. XR environments, on the other hand, can leverage a broader spectrum for providing notifications including, for example, smell, holographic images, rich visual notifications in head mounted displays and others.

These new ways for providing notifications to users in XR environments cause stress on existing mechanisms for choosing how to notify people since a simple user interface where every user is asked to select their preferred way of notification would be cumbersome and very complex—that is, for x events with n types of notification, the user will have to make x*n choices. In addition, some notifications, which may not even be defined yet, may not be appropriate for different users. For example, creating the sensation of rain in a wearable XR user device to indicate a change in the weather may be appropriate for some users, while others may find that displeasing, and instead prefer a more visual avenue or just an auditory notification.

In the state of the art, such problems are typically solved using techniques such as collaborative filtering which operate on singular relationships between users and items (or notifications in this case) to perform matrix completion and produce relevant recommendation. However, such techniques are not sufficient to address these problems given the more complex set of relations between users and other users, users and different types of notifications, and how each notification affects the emotional state of each user. Such techniques are further insufficient to address these problems in that there is no feedback mechanism, which enables learning how each notification affects each user.

Considering the emotional state of a user, reference [1], Dzedzickis A, Kaklauskas A, Bucinskas V. Human Emotion Recognition: Review of Sensors and Methods. Sensors (Basel). 2020; 20(3):592. Published 2020 Jan. 21. doi:10.3390/s20030592 (https://www.ncbi.nlm.nih.gov/pmc/articles/PMC7037130/), provides an excellent overview of techniques, using non-invasive wearable and portable sensors and less-portable devices alike, to measure and evaluate how sensory stimuli affect human arousal and valence, where valence refers to how positive/pleasant a given stimulus feels and arousal refers to how activated/attentive the stimulus feels. Arousal/attention and valence/pleasure can be measured using, for example, minimally invasive detectors of skin conductivity—possibly even while typing on a smartphone (see, e.g., [2] Roy Francis Navea et al Stress Detection using Galvanic Skin Response: An Android Application. 2019 J. Phys.: Conf. Ser. 1372 012001 (https://iopscience.iop.org/article/10.1088/1742-6596/1372/1/012001))—or heart rate variability by, for example, a smartphone camera light (see, e.g., [1], Dzedzickis A, Kaklauskas A, Bucinskas V. Human Emotion Recognition: Review of Sensors and Methods. Sensors (Basel). 2020; 20(3):592. Published 2020 Jan. 21. doi:10.3390/s20030592 (https://www.ncbi.nlm.nih.gov/pmc/articles/PMC7037130/)) or a wristband (see, e.g., [3] Seshadri, D. R., Li, R. T., Voos, J. E. et al. Wearable sensors for monitoring the physiological and biochemical profile of the athlete. npj Digit. Med. 2, 72 (2019) (https://www.nature.com/articles/s41746-019-0150-9)).

For instance, regarding skin conductivity, “[e]motional changes induce sweat reactions, which are mostly noticeable on the surface of the hands, fingers and the soles. Sweat reaction causes a variation of the amount of salt in the human skin and this leads to the change of electrical resistance of the skin. <. . . > Skin conductance is mainly related with the level of arousal: if the arousal level is increased, the conductance of the skin also increases. <. . . > Attention-grabbing stimuli and attention-demanding tasks lead to the simultaneous increase of the frequency and magnitude of skin conductance.” See, e.g., [1], Dzedzickis A, Kaklauskas A, Bucinskas V. Human Emotion Recognition: Review of Sensors and Methods. Sensors (Basel). 2020; 20(3):592. Published 2020 Jan. 21. doi:10.3390/s20030592 (https://www.ncbi.nlm.nih.gov/pmc/articles/PMC7037130/).

Similarly, heart rate variability (HRV)—i.e., beat-to-beat variation in time within a certain period—, correlates with changes in arousal and valence. HRV is, however, also influenced by factors such as emotions, stress and physical exercise, and depends on factors such as age, gender, consumption of coffee or alcohol, blood pressure among others. Such and similar measures are thereby user specific. Relational information about users could thus be important in determining which XR notifications are more appropriate for which users.

### SUMMARY

Embodiments disclosed herein overcome the foregoing challenges and problems by providing a mechanism that identifies the most appropriate way to deliver personalized notifications to users by learning from their reaction and then associating that to other user's reactions. Embodiments disclosed herein use a machine learning (ML) model, referred to as a recommendation engine, which can exploit the existing quantifiable measures of human states of attention and pleasure and, thus, the relationship between people and XR notifications, as well as the dependence of those measures on human factors and, thereby, the characteristics of groups of people.

In some embodiments, the recommendation engine provided is based on a graph neural network (GNN). This GNN-based solution is designed to be assisted by, for example, a cloud infrastructure. In exemplary embodiments, a triple graph approach is used in which a triple graph is created and learns to associate users with other users with their emotional state and with different contexts. The downstream task for this graph is then pushed to a multi-layer perceptron (MLP) which learns to predict a rating for each notification type. One benefit of this approach is that it can leverage a lot of information from multiple users, multiple contexts and multiple notification types. One consideration with the GNN-based solution is that this information is copied into a cloud infrastructure—which is something that typically would require a user's consent as it deals with private information.

In some embodiments, the recommendation engine provided is based on reinforcement learning (RL). This RL-based solution is designed to be personalized, as the information used is maintained in the user's device. One consideration with the RL-based solution is that, unlike the GNN-based solution, the RL-based solution only works with the user's specific emotional state and not with information from other users.

Basically, in both cases (RL and GNN), the user's emotional state, which is, for example, a vector of n-elements (including measurements of anger, happiness etc.), is considered. In the case of GNN, when a recommendation about a notification type is produced, the expected emotional state (how the user will feel when they will receive information using that notification type) is also produced. By comparing the recommendations with the local preferences (which is now reduced to a vector comparison), the selection can be adjusted to those notification types that approximate (have the smallest difference) with the local preferences. In the case of RL, instead of rewarding the algorithm to match the predicted emotional state, we reward to match the wanted emotional state.

According to one aspect, a computer-implemented method for determining, using a machine learning (ML) model, extended reality (XR) notification types for delivering notification of an event to a user is provided. The method includes receiving user information, wherein the user information includes user characteristics and relationships data; receiving event information, wherein the event information includes event type data; determining, using a machine learning (ML) model, recommended notification types for delivering notification of the event to the user and, for each recommended notification type, predicted emotional state information including a predicted emotional state of the user and a rating; receiving local preferences information for the user, wherein the local preferences information includes one or more of local preferences for different notification types, different event types, and different wanted emotional states; selecting the notification type for delivering the notification of the event to the user by comparing, for each recommended notification type, the predicted emotional state information and the local preferences information; and delivering the notification of the event to the user using the selected notification type.

In some embodiments, the ML model is a graph neural network (GNN). In some embodiments, the method includes collecting data including user information, notification information and context information, wherein the user information includes user characteristics and relationships data, the notification information includes notification types and relationships data, and the context information includes context types and relationships data; building, using the user characteristics and relationships data, a user-to-user dependency graph representing associations between users; generating, using the user-to-user dependency graph, first user embeddings; building, using the context types and relationships data and the notification types and relationships data, a context-to-notification dependency graph representing associations between contexts and notifications; generating, using the context-to-notification dependency graph, first notification embeddings and context embeddings; building, using the first notification embeddings and the first user embeddings, a notification-to-user dependency graph representing associations between users and notifications; and generating, using the notification-to-user dependency graph, second notification embeddings and second user embeddings; combining the generated first and second user embeddings, first and second notification embeddings and context embeddings; and training the GNN using the combined embeddings to predict recommended notification types for delivering notifications of events to users and, for each recommended notification type for each user, predicted emotional state information including a predicted emotional state of the user and a rating.

In some embodiments, the method includes receiving user rating information for the notification delivered to the user, wherein the user rating information includes actual emotional state information for the user; and using the received user rating information for retraining the GNN. In some embodiments, the user characteristics and relationships data includes one or more of: age, gender, education, interests, friend status, and social networks status. In some embodiments, the notification types and relationships data includes one or more of: visual, auditory, tactile, smell, taste, and receiving device type. In some embodiments, the context types and relationships data includes one or more of: alarm, meeting, weather change, advertisement, activity type, indoor, outdoor, spatial information, physical distance, and geographical location. In some embodiments, the event type data includes one or more of: alarm, weather change, new email, new voicemail, new message, news, announcement, and advertisement. In some embodiments, the emotional state of the user corresponds to one or more of: angry, tense, excited, elated, happy, relaxed, calm, exhausted, tired, sad, a measure of valence, and a measure of arousal. In some embodiments, the local preferences information for the user is based on one or more of: different levels of attentiveness the user is experiencing and different emotional states of the user that the user has deprioritized.

According to another aspect, a central computing device for determining, using a machine learning (ML) model, extended reality (XR) notification types for delivering notification of an event to a user is provided. The central computing device includes a memory and a processor coupled to the memory. The processor is configured to: receive user information, wherein the user information includes user characteristics and relationships data; receive event information, wherein the event information includes event type data; determine, using a machine learning (ML) model, recommended notification types for delivering notification of the event to the user and, for each recommended notification type, predicted emotional state information including a predicted emotional state of the user and a rating; receive local preferences information for the user, wherein the local preferences information includes one or more of local preferences for different notification types, different event types, and different wanted emotional states; select the notification type for delivering the notification of the event to the user by comparing, for each recommended notification type, the predicted emotional state information and the local preferences information; and deliver the notification of the event to the user using the selected notification type.

In some embodiments, the ML model is a graph neural network (GNN). In some embodiments, the processor is further configured to: collect data including user information, notification information and context information, wherein the user information includes user characteristics and relationships data, the notification information includes notification types and relationships data, and the context information includes context types and relationships data; build, using the user characteristics and relationships data, a user-to-user dependency graph representing associations between users; generate, using the user-to-user dependency graph, first user embeddings; build, using the context types and relationships data and the notification types and relationships data, a context-to-notification dependency graph representing associations between contexts and notifications; generate, using the context-to-notification dependency graph, first notification embeddings and context embeddings; build, using the first notification embeddings and the first user embeddings, a notification-to-user dependency graph representing associations between users and notifications; generate, using the notification-to-user dependency graph, second notification embeddings and second user embeddings; combine the generated first and second user embeddings, first and second notification embeddings and context embeddings; and train the GNN using the combined embeddings to predict recommended notification types for delivering notifications of events to users and, for each recommended notification type for each user, predicted emotional state information including a predicted emotional state of the user and a rating.

According to another aspect, a method for a computer-implemented method for determining, using unsupervised reinforcement machine (RL), extended reality (XR) notification types for delivering notifications of events to a user, the method includes initializing a deep Q neural network (DQN) to be used for learning associations between actions and rewards is provided. The actions include, for each event, a recommended notification type and associated predicted emotional state of the user. The method also includes initializing a buffer of experiences data to be used as a training set for the DQN. The method also includes, for each episode i in a plurality of episodes K, where each episode corresponds to an event: (i) identifying an event that has occurred; (ii) selecting an action including a recommended notification type for the event based on one of: a policy and expected rewards from the learned associations of the rewards and the action represented in the DQN; (iii) identifying local preferences information for the user, wherein the local preferences information includes one or more of local preferences for different notification types, different event types, and different wanted emotional states; (iv) determining whether to select a different action including a different recommended notification type for the event based on the local preferences information for the user; (v) delivering, based on the selected action, the notification of the event to the user using the recommended notification type; (vi) observing the reward from using the recommended notification type including the current emotional state information for the user; (vii) storing in the buffer experiences data including the current and previous emotional state information for the user, the selected action, and the reward; and (viii) repeating steps (i) to (vii) Y times. The method also includes (ix) training the DQN using the experiences data stored in the buffer; (x) generating weights learned from training the DQN; (xi) copying the generated weights to the DQN; (xii) repeating steps (x) to (xi) M times; and (xiii) repeating steps (i) to (xiii) K times. The method also includes receiving event information, wherein the event information includes event type data; determining, using the trained DQN, a recommended notification type for delivering notification of the event to the user; and delivering the notification of the event to the user using the determined notification type.

In another aspect there is provided a computer program comprising instructions which, when executed by processing circuity of a device causes the device to perform the methods. In another aspect there is provided a carrier containing the computer program, where the carrier is one of an electronic signal, an optical signal, a radio signal, and a computer readable storage medium.

The embodiments disclosed herein are advantageous for numerous reasons. For example, using the methods disclosed herein, the user no longer has to configure expected notifications for different events manually. Instead, either a centralized GNN-based approach can learn that and correlate it with other users, or a more personalized RL approach can be used to learn that for a specific user, thus preserving privacy.

### BRIEF DESCRIPTION OF THE DRAWINGS

The accompanying drawings, which are incorporated herein and form part of the specification, illustrate various embodiments.

FIG. 1 is a block diagram illustrating an architecture for a central computing device and local computing devices in an XR environment, according to some embodiments.

FIG. 2 is a block diagram illustrating an XR system, according to some embodiments.

FIG. 3 is a block diagram of components of an XR system, according to some embodiments.

FIG. 4 illustrates a mapping of emotions to a set of measureable dimensions, according to some embodiments.

FIG. 5 illustrates a triple graph, according to some embodiments.

FIG. 6 illustrates a graph neural network, according to some embodiments.

FIG. 7 illustrates computation neural network graphs, according to some embodiments.

FIG. 8 is a flowchart illustrating a process, according to some embodiments.

FIG. 9 is a flowchart illustrating a process, according to some embodiments.

FIG. 10 illustrates a message sequence diagram, according to some embodiments.

FIG. 11 is a block diagram illustrating an architecture for a local computing device in an XR environment, according to some embodiments.

FIG. 12 is a flowchart illustrating a process, according to some embodiments.

FIG. 13 illustrates a message sequence diagram, according to some embodiments.

FIG. 14 is a block diagram of an apparatus according to an embodiment.

FIG. 15 is a block diagram of an apparatus according to an embodiment.

### DETAILED DESCRIPTION

This disclosure describes a computer-implemented method for determining, using a machine learning (ML) model, extended reality (XR) notification types for delivering notification of an event to a user. The method includes receiving user information. The user information includes user characteristics and relationships data. The method also includes receiving event information. The event information includes event type data. The method also includes determining, using a ML model, recommended notification types for delivering notification of the event to the user and, for each recommended notification type, predicted emotional state information including a predicted emotional state of the user and a rating. The method also includes receiving local preferences information for the user. The local preferences information includes one or more of local preferences for different notification types, different event types, and different wanted emotional states. The method also includes selecting the notification type for delivering the notification of the event to the user by comparing, for each recommended notification type, the predicted emotional state information and the local preferences information. The method also includes delivering the notification of the event to the user using the selected notification type.

As discussed in further detail below, the methods and devices disclosed herein use a ML model, referred to as a recommendation engine, which can exploit the existing quantifiable measures of human states of attention and pleasure and, thus, the relationship between people and XR notifications, as well as the dependence of those measures on human factors and, thereby, the characteristics of groups of people.

In some embodiments, the recommendation engine provided is based on a graph neural network (GNN). This GNN-based solution is designed to be assisted by, for example, a cloud infrastructure. In exemplary embodiments, a triple graph approach is used in which a triple graph is created and learns to associate users with other users with their emotional state and with different contexts. The downstream task for this graph is then pushed to a multi-layer perceptron (MLP) which learns to predict a rating for each notification type.

In some embodiments, the recommendation engine provided is based on reinforcement learning (RL). This RL-based solution is designed to be personalized, as the information used is maintained in the user's device.

Basically, in both cases (RL and GNN), the user's emotional state, which is, for example, a vector of n-elements (including measurements of anger, happiness etc.), is considered. In the case of GNN, when a recommendation about a notification type is produced, the expected emotional state (how the user will feel when they will receive information using that notification type) is also produced. By comparing the recommendations with the local preferences (which is now reduced to a vector comparison), the selection can be adjusted to those notification types that approximate (have the smallest difference) with the local preferences. In the case of RL, instead of rewarding the algorithm to match the predicted emotional state, we reward to match the wanted emotional state.

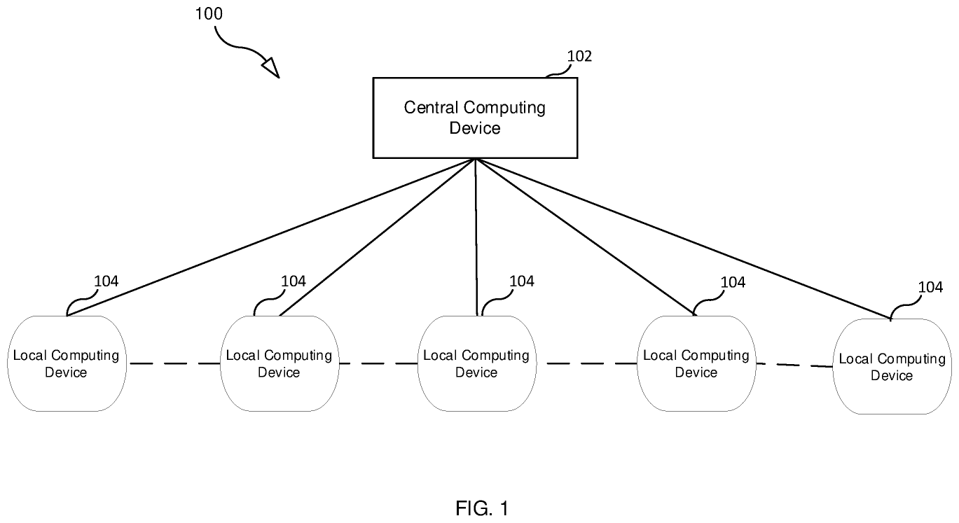

FIG. 1 is a block diagram illustrating an architecture for a central computing device and local computing devices in an XR environment, according to some embodiments. As shown, a central computing device 102 is in communication with one or more local computing devices 104. As described in further detail herein, in some embodiments, a local client or user is associated with a local computing device 104, and a global user is associated with a central server or computing device 102. In some embodiments, local computing devices 104 or local users may be in communication with each other utilizing any of a variety of network topologies and/or network communication systems. In some embodiments, central computing device 102 may include a server device, cloud server or the like. In some embodiments, local computing devices 104 may include user devices or user equipment (UE), such as a mobile device, smart phone, tablet, laptop, personal computer, and so on, and may also be communicatively coupled through a common network, such as the Internet (e.g., via WiFi), or a communications network (e.g., a 3GPP-type cellular network, LTE or 5G), or other type of network. While a central computing device is shown, the functionality of central computing device 102 may be distributed across multiple nodes, computing devices and/or servers, and may be shared between one or more of the local computing devices 104.

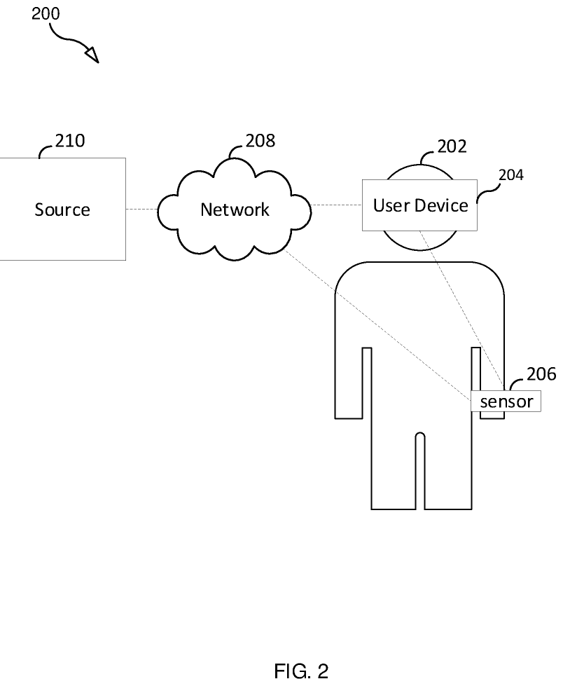

FIG. 2 is a block diagram illustrating an XR system 200, according to some embodiments. As shown in FIG. 2, a user device 204, for example a user equipment (UE) or XR user device, is in communication with a source 210 via network 208. In some embodiments, user device 204 is in communication with source 210 directly without network 208. The user device 204 may encompass, for example, a mobile device, smart phone, computer, tablet, desktop, or other device used by an end-user capable of controlling a sensor 206 or sensory actuator, such as a screen or other digital visual generation devices, digital scent generator capable of creating aroma or scent, taste generator device that can recreate taste sensations associated with food, speakers or other auditory devices, and haptic feedback or other touch sensory devices. For example, device 204 may encompass a device used for XR, AR, VR, or MR applications, such as a headset, that may be wearable on a user 202. The source 210 may encompass an application server, network server, or other device capable of producing sensory datastreams for processing by the user device 204. For example, in a third-generation partnership project (3GPP) network, this source 210 could be a camera, a speaker/headphone, or another party providing data via an eNB/gNB. The network 210 may be a common network, such as the Internet (e.g., via WiFi), or a communications network (e.g., a 3GPP-type cellular network, LTE or 5G), or other type of network. In some embodiments, a sensor 206 may be in electronic communication with the user device 204 directly and/or via network 208. In some embodiments, sensor 206 may be in electronic communication with other devices, such as source 210, via network 208. The sensor 206 may have capabilities of, for example, measuring one or more of: HRV, SKT, RRA, FE, BP, GA, EOG, EEG, ECG, GSR, or EMG for user 202.

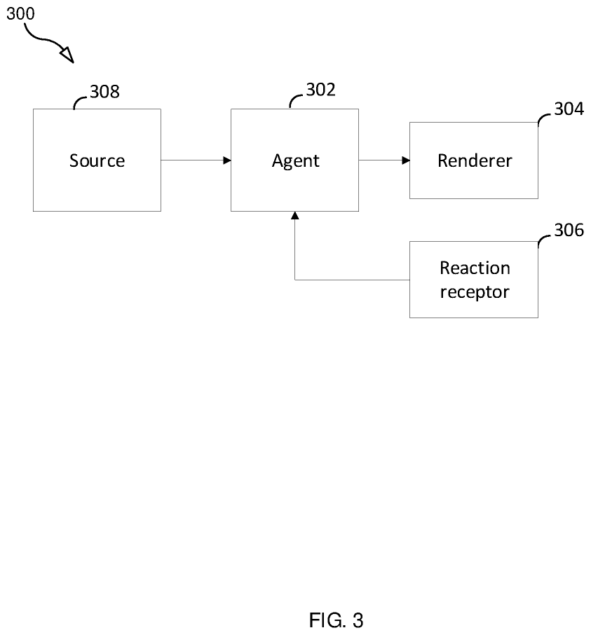

FIG. 3 is a block diagram of components of an XR system 300, according to some embodiments. The system 300 may encompass a datastream processing agent 302, a renderer 304, and reaction receptor 306, and source 308 described above in connection with FIG. 2. In some embodiments, datastream processing agent 302 resides in device 204. The data processing agent 302 may include a set of components used to learn, based on a user's emotional state and personal preferences, how to adjust the intensity of different senses and modify the raw datastreams from source 308 accordingly. Processed datastreams may be sent from data processing agent 302 to renderer 304, e.g., to control a sensor actuator in accordance with the processed datastreams. For example, renderer 304 may be VR goggles, glasses, a phone, or other device.

Depending on the technique used to gauge users' reactions, different sensors 206 can also be used and even placed on user's body. The reaction receptor 306 may measure a user's emotional state and/or measure environmental qualities and provide such information to datastream processing agent 302. In some embodiments, reaction receptor 306 may aggregate information from one or more sensors 206.

If automated identification of the basic emotions using sensors is impractical (e.g. visual sensors for facial expressions, body posture and gestures are unavailable), a multi-dimensional analysis of emotional states could be used instead. Multi-dimensional analysis pertains to mapping emotions to a limited set of measurable dimensions, for instance valence and arousal. Valence refers to how positive/pleasant or negative/unpleasant a given experience feels and arousal refers to how activated/attentive the experience feels.

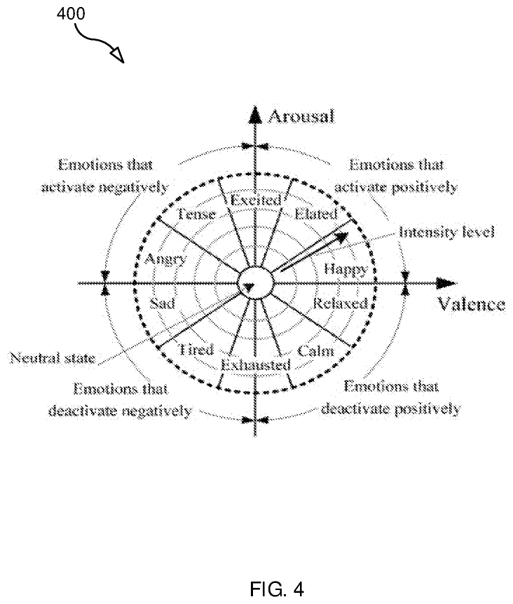

FIG. 4 illustrates a mapping of emotions to a set of measureable dimensions, according to some embodiments. An overview of approaches to emotion recognition and evaluation using techniques such as galvanic skin response (GSR), heart rate variability (HRV), skin temperature measurements (SKT), electrocardiography (ECG), electroencephalography (EEG) is described in Reference [1]. More or less invasive sensors can be used to measure emotional states along the dimensions: e.g. if the arousal level is increased, the conductance of the skin also increases, the heart rate increases etc.; the latter can be measured using various wearable sensors. What is more, such dimensions and thereby emotional states can be captured using even typical devices such as smartphones via direct user input, for example, using the Mood Meter App.

A main focus of the methods and devices disclosed herein is that of emotion recognition and the ability to recognize how each notification affects a user emotionally, and then to be able to associate that back to the type of the notification and the person, so that we can eventually reproduce (recommend) the same type of notification to similar people in a similar context. As indicated above, in some embodiments, this recommendation engine is based on a graph neural network (GNN) and, in other embodiments, this recommendation engine provided is based on reinforcement learning (RL).

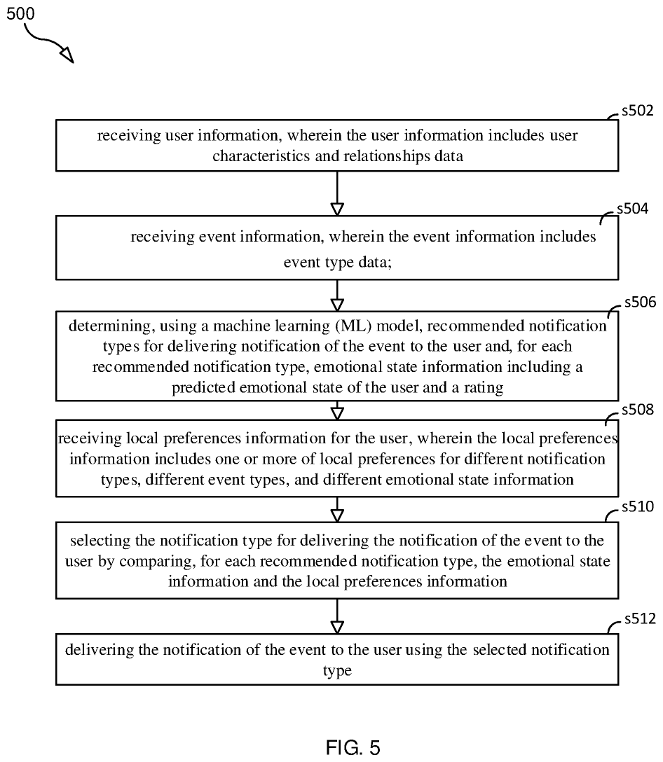

FIG. 5 is a flowchart illustrating a process 500 according to some embodiments. Process 500 may begin with step s502.

Step s502 comprises receiving user information, wherein the user information includes user characteristics and relationships data.

Step s504 comprises receiving event information, wherein the event information includes event type data.

Step s506 comprises determining, using a machine learning (ML) model, recommended notification types for delivering notification of the event to the user and, for each recommended notification type, predicted emotional state information including a predicted emotional state of the user and a rating.

Step s508 comprises receiving local preferences information for the user, wherein the local preferences information includes one or more of local preferences for different notification types, different event types, and different wanted emotional states.

Step s510 comprises selecting the notification type for delivering the notification of the event to the user by comparing, for each recommended notification type, the predicted emotional state information and the local preferences information.

Step s512 comprises delivering the notification of the event to the user using the selected notification type.

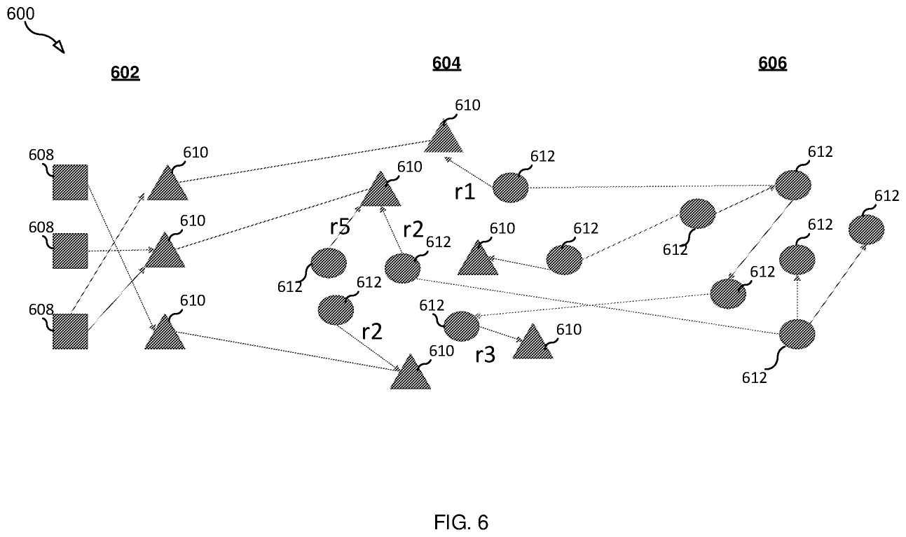

For the methods and devices of embodiments with a recommendation engine including an ML model based on a GNN, three graphs, for example, are used as illustrated in FIG. 6.

FIG. 6 illustrates a triple graph 600. Each graph, context to notification 602, notification to user 604, and user to user 606 describes a distinct relationship. Iterating from left to right, with reference to the context to notification graph 602, we start with the association between context, shown as rectangles 608, and notifications, shown as triangles 610. In this space, we want to learn a representation that combines context as described by its feature space. By context here, we refer to the context under which a notification originates from. We consider the feature space to have at least one categorical feature, which is the type of context which could be an alarm, a meeting, weather change, advertisement, and any other informative material. Within this graph 602, we associate context with the different types of notifications that are relevant for such context for example, an auditory notification could be the only type of notification that we may want to associate an alarm with but for weather changes we may want to have a choice between more types of notifications that could be visual, auditory, or even smell.

Moving to the center notification to user graph 604, here we want to associate users, shown as circles 612, with notifications, shown as triangles 610. In addition, here we consider weighted edges to mark how pleased/displeased a user was with the notification they received while within a certain context. Users are represented by their embedding which is produced by the right most user to user graph 606, while notifications are represented by their embedding which is produced by the left-most context to notification graph 602. Without loss of generality, and with reference to FIG. 4, the rating can be produced using Russel's circumplex model of emotions, which can be represented as a 10-dimensional array which measures a user's emotional state—i.e., angry, tense, excited, elated, happy, relaxed, calm, exhausted, tired, and sad, as further detailed in reference [1].

Referring to FIG. 6, the right most user to user graph 606 produces a representation which associates users to users in, for example, a social network context. A link between two users, shown as circles 612, indicates that the users are related, i.e., they are friends or that they are similar in terms of their feature space. By feature space here we refer to the characteristics of each user, such as age, sex, education, and their interests. The relationship here can be determined using clustering algorithms such as k-means, or alternatively obtained from external sources.

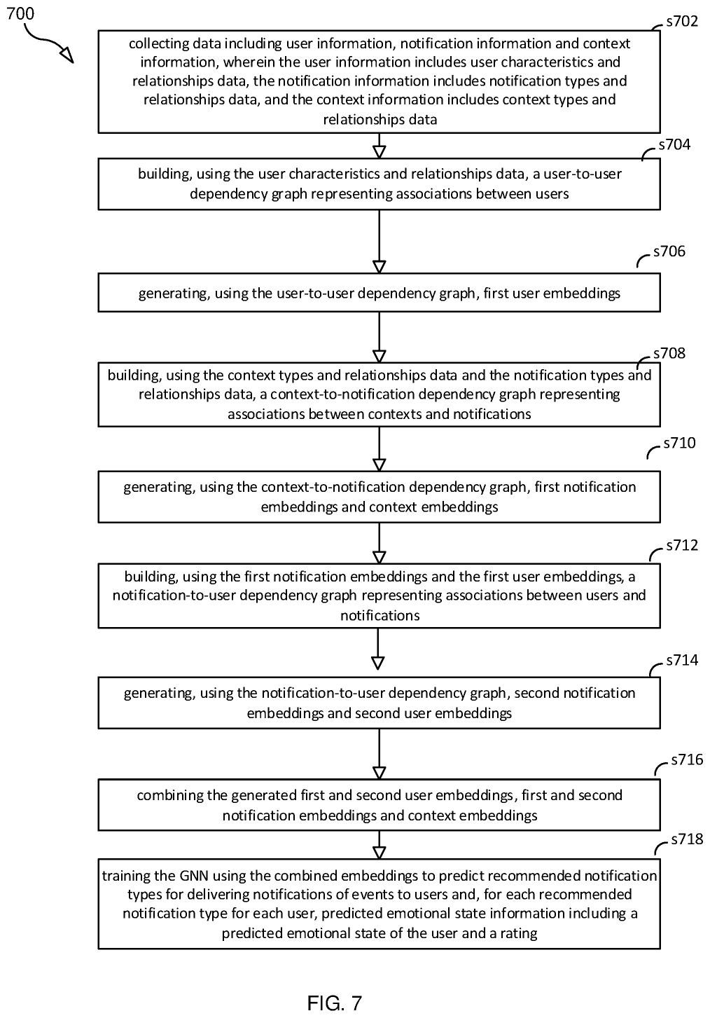

FIG. 7 is a flowchart illustrating a process 700, according to some embodiments. As discussed, in some embodiments, the ML model is a graph neural network (GNN). For those embodiments in which the recommendation engine provided is based on a GNN, the process 700 may begin with step s702.

Step s702 comprises collecting data including user information, notification information and context information, wherein the user information includes user characteristics and relationships data, the notification information includes notification types and relationships data, and the context information includes context types and relationships data.

Step s704 comprises building, using the user characteristics and relationships data, a user-to-user dependency graph representing associations between users.

Step s706 comprises generating, using the user-to-user dependency graph, first user embeddings.

Step s708 comprises building, using the context types and relationships data and the notification types and relationships data, a context-to-notification dependency graph representing associations between contexts and notifications.

Step s710 comprises generating, using the context-to-notification dependency graph, first notification embeddings and context embeddings.

Step s712 comprises building, using the first notification embeddings and the first user embeddings, a notification-to-user dependency graph representing associations between users and notifications.

Step s714 comprises generating, using the notification-to-user dependency graph, second notification embeddings and second user embeddings.

Step s716 comprises combining the generated first and second user embeddings, first and second notification embeddings and context embeddings.

Step s718 comprises training the GNN using the combined embeddings to predict recommended notification types for delivering notifications of events to users and, for each recommended notification type for each user, predicted emotional state information including a predicted emotional state of the user and a rating.

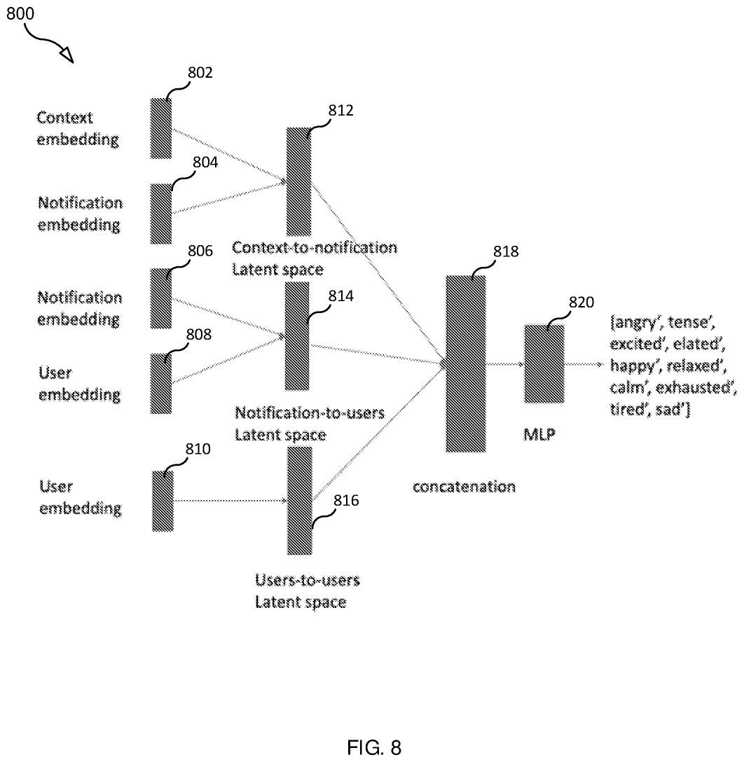

FIG. 8 illustrates a GNN 800, according to some embodiments. The GNN 800 shown in FIG. 8 is known as a message passing graph neural network, since message passing is the technique that is used to produce the different embeddings that are later concatenated. Message passing aims at producing a vector H which is the concatenation of multilayer perceptrons (MLPs) that use as input the features of each node and of each edge for a sequence of hops in a graph.

H is produced using the following equation:

$${h}_{u}^{k + 1} = {UPDATE}^{( K )} ( {h}_{u}^{( k )} , {AGGREGATE}^{( K )} ( \{ {h}_{u}^{( k )} , ∀ v ∈ N ( u ) \} ) ) = {UPDATE}^{( k )} ( {h}_{u}^{( k )} , {m}_{N ( u )}^{( k )} )$$

h represents the embedding that is produced by GNN 800 for a given node u when the k-th update is performed. What the equation shows is that the embedding of every node u depends on the updated aggregate of each embedding that is produced by every neighbor of u where every neighbor belongs to the set of N(u), where N is a function that yields the neighbors for every node. The aggregate is typically a concatenation function. Since the model is trained to produce the embeddings, k tracks the iteration of the training process. The latent space, discussed further below, is basically the collection of all those embeddings that are produced by the message passing process.

Referring to FIG. 8, the GNN 800 includes nodes arranged in a hierarchical structure. The layer 1 nodes include context embedding node 802, notification embedding node 804, notification embedding node 806, user embedding node 808, and user embedding node 810. The layer 2 nodes include context-to-notification latent space node 812, notification-to-users latent space node 814, and users-to-users latent space node 816. The layer 3 node is concatenation node 818. The layer 4 node is a MLP node 820

For example, in the case of user embeddings the input is a graph where every node contains a set of features that represent the user (features can be age, sex and others) and the edges between the nodes (users) determine whether the users are related or not. Using such an input the graph embedding (user embedding in this case) is produced by applying a linear transformation (such as an MLP) to the features of every node and then aggregating these features only for the nodes that are related.

In the case of notification embeddings, for example, the input features are the features of each notification (such as the type of the notification (audio/visual) and others) and the edges are the relations between the notifications i.e., if they are coming from the same source.

In the case of context embeddings, for example, the input features are the features of each context (indoor/outdoor, activity type) and the edges are the relationship between contexts i.e., if we consider spatial contexts the physical distance between the geographical location of each context.

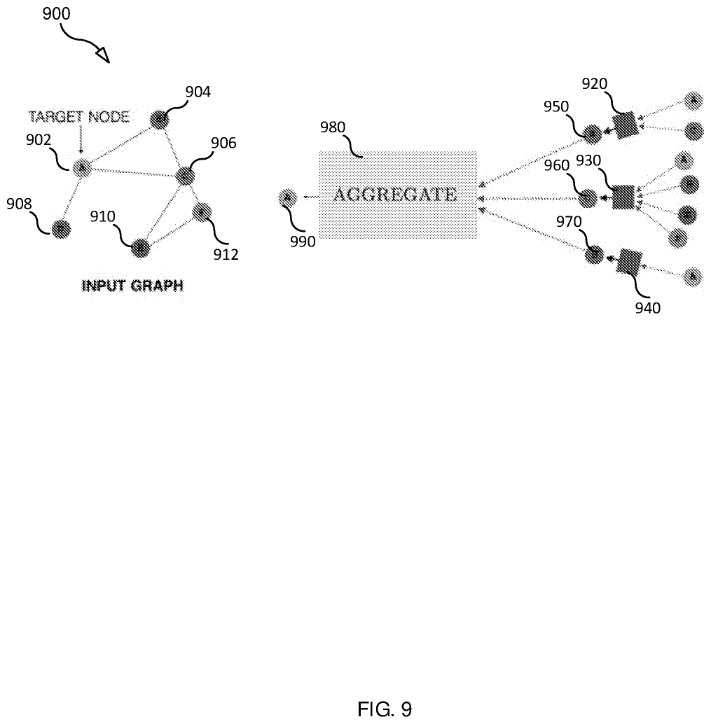

FIG. 9 illustrates computation neural network graphs 900, according to some embodiments, which show the aggregation function and process for generating the embeddings. The illustration shown in FIG. 9, with reference to the equation referenced above, are shown and explained in William L. Hamilton (2020), Graph Representation Learning, Synthesis Lectures on Artificial Intelligence and Machine Learning, Vol. 14, No. 3, Pages 1-159 at 49. With reference to FIG. 9, there are 6 nodes A 902, B 904, C 906, D 908, E 910, and F 912. The embeddings (h) are produced by the boxes 920, 930, and 940. Referring to the top-right hand side, an embedding of node B 950, which uses as input its neighbors A and C, is produced. The input here is the feature space of A and C, for example their attributes—if A was a person, it would have attributes such as gender, height etc. Referring to the middle-right hand side, an embedding of node C 960, which uses as input its neighbors A, B, E and F, is produced. Referring to the bottom-right hand side, an embedding of node D 970, which uses as input its neighbor A, is produced. By this process, the embedding (h) of A 990 is produced, which is the aggregate 980 of the embeddings of the neighbors of A which are B 950, C 960, and D 970, which is why there are 3 inputs to this function. This is a recursive process, where for every embedding, we identify its neighbors and then compute embeddings using its neighbors and so on, for as long as there is an edge between the nodes that are being added to this process. If there is no edge, then the node is not considered.

In some embodiments, the method includes receiving user rating information for the notification delivered to the user, wherein the user rating information includes actual emotional state information for the user; and using the received user rating information for retraining the GNN.

In some embodiments, the user characteristics and relationships data includes one or more of: age, gender, education, interests, friend status, and social networks status. In some embodiments, the notification types and relationships data includes one or more of: visual, auditory, tactile, smell, taste, and receiving device type.

In some embodiments, the context types and relationships data includes one or more of: alarm, meeting, weather change, advertisement, activity type, indoor, outdoor, spatial information, physical distance, and geographical location.

In some embodiments, the event type data includes one or more of: alarm, weather change, new email, new voicemail, new message, news, announcement, and advertisement.

In some embodiments, the emotional state of the user corresponds to one or more of: angry, tense, excited, elated, happy, relaxed, calm, exhausted, tired, sad, a measure of valence, and a measure of arousal.

In some embodiments, the local preferences information for the user is based on one or more of: different levels of attentiveness the user is experiencing and different emotional states of the user that the user has deprioritized.

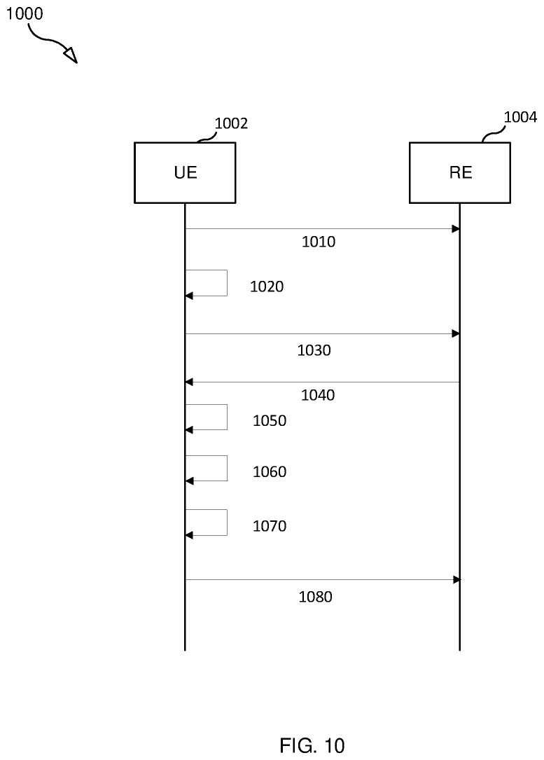

FIG. 10 illustrates a message sequence diagram 1000, according to some embodiments. UE 1002 may be local computing device 104, user device 204, user equipment, or an XR user device, as discussed above. RE 1004 is the recommendation engine, as discussed above, which, in some embodiments is based on a graph neural network (GNN). The message sequence diagram 1000 of FIG. 10 illustrates an exemplary process for determining, using the recommendation engine 1004, XR notification types for delivering notification of an event to a user.

At 1010, the UE 1002 registers with the RE 1004. This is a one-off step and does need to happen multiple times. Within this step, the user also provides information about themselves which can help the recommendation engine (for example, details about their gender, their relationships with other users, etc.).

At 1020, we assume that an event occurs (i.e., an alarm, weather change, other type of event). This may be esoteric to the UE 1002 or it may come from an external third-party source. When that occurs, at 1030, the UE 1002 will consult the RE 1004. In response, at 1040, the RE 1004 provides an array of tuples which describe the different ways to deliver the notification to the user, the predicted emotional state that the notification type will create to the user (e1, e2, . . . ) along with a rating for each of those (r1, r2, . . . ).

At 1050, we consider a selection process which considers local preferences that the user may have about the different types of notification for example the user may be in an agitated state therefore at that point in time they may favor only relaxed notifications. To accommodate for different contexts the user might find themselves in, the set of local preferences may be selected based on the determined XR context corresponding to different levels of attentiveness they currently experience—e.g., if it is determined that the user is playing a game in XR, a different set of local preferences is activated in comparison to when the user is enjoying an immersive music concert.

Local preferences can be formulated as a table containing one or more rows where each row can be a specific local preference for a certain event for example:

| event | Local_preference_vector |
|---|---|
| “alarm” | [a1, te1, e1, el1, h1, r1, c1, ex1, ti1, s1] |
| “new_email_notification” | [a2, te2, e2, el2, h2, r2, c2, ex2, ti2, s2] |

Alternatively, local preferences can be defined in a more general sense i.e., there may be a local preference that forbids the system to select a notification that may cause the user to feel anger or fear.

Given the specific local_preference, we can further rank the output of notification_types. For that, we compare the expected emotional state (e1, e2,) of each notification types with local preferences using techniques such as cosine similarity:

$$similarity = \frac{A * B}{‖ A ‖ * ‖ B ‖}$$

Other techniques can be used, such as, for example, L1-norm.

Each vector (e1, e2,) is the predicted emotional state as produced by the RE 1004. As such, it is also a vector similar to the local preference_vector.

Example: e1=[a1′,te1′,e1′,el1′, h1′, r1′, c1′, ex1′, ti1′, s1′]

In the case where we want to adapt the notification type produced by the RE 1004 with that of the local preference, we can use cosine similarity to choose the notification type which is most similar to the local preference (instead of choosing the one with the highest rating).

Once this choice has been made, at 1060. the notification is rendered. Thereafter, at 1070, the user responds to the notification. We rely on the way that the user responds to the notification to rate it. Different techniques that can be used for doing this are described in, for example, reference [1], Dzedzickis A, Kaklauskas A, Bucinskas V. Human Emotion Recognition: Review of Sensors and Methods. Sensors (Basel). 2020; 20(3):592. Published 2020 Jan. 21. doi:10.3390/s20030592 (https://www.ncbi.nlm.nih.gov/pmc/articles/PMC7037130/), which provides an overview of techniques, using non-invasive wearable and portable sensors and less-portable devices alike, to measure and evaluate how sensory stimuli affect human arousal and valence, where valence refers to how positive/pleasant a given stimulus feels and arousal refers to how activated/attentive the stimulus feels. Arousal/attention and valence/pleasure can be measured using, for example, minimally invasive detectors of skin conductivity—possibly even while typing on a smartphone (see, e.g., [2] Roy Francis Navea et al Stress Detection using Galvanic Skin Response: An Android Application. 2019 J. Phys.: Conf. Ser. 1372 012001 (https://iopscience.iop.org/article/10.1088/1742-6596/1372/1/012001))—or heart rate variability by, for example, a smartphone camera light (see, e.g., [1], Dzedzickis A, Kaklauskas A, Bucinskas V. Human Emotion Recognition: Review of Sensors and Methods. Sensors (Basel). 2020; 20(3):592. Published 2020 Jan. 21. doi:10.3390/s20030592 (https://www.ncbi.nlm.nih.gov/pmc/articles/PMC7037130/)) or a wristband (see, e.g., [3] Seshadri, D. R., Li, R. T., Voos, J. E. et al. Wearable sensors for monitoring the physiological and biochemical profile of the athlete. npj Digit. Med. 2, 72 (2019) (https://www.nature.com/articles/s41746-019-0150-9)).

At 1080, the user's rating of the notification is sent back to the RE 1004 and it is added in the triple graph described above to be used again when the GNN will be retrained.

In an exemplary embodiment, the GNN-based recommendation engine is a centralized approach, which takes advantage of multiple input sources to accurately predict the rating for a notification that is most likely to provoke a specific emotional reaction to a user. One interesting dimension is that the goal of this recommendation engine is not limited to produce only positive reactions-over time it is possible to use this to produce any kind of reactions as deemed appropriate by the user. One consideration of this approach is that it requires a lot of input which the user may not be inclined to share due to privacy concerns.

In an alternative embodiment, the GNN-based recommendation engine is replaced with an RL agent, which instead of learning how to predict the rating of a notification by combining the representation of context to notification to user, instead learns from the reward function which is associated with the feedback that the user supplies when served a specific notification. Thus, overtime the system learns to provide the most rewarding notifications for that user.

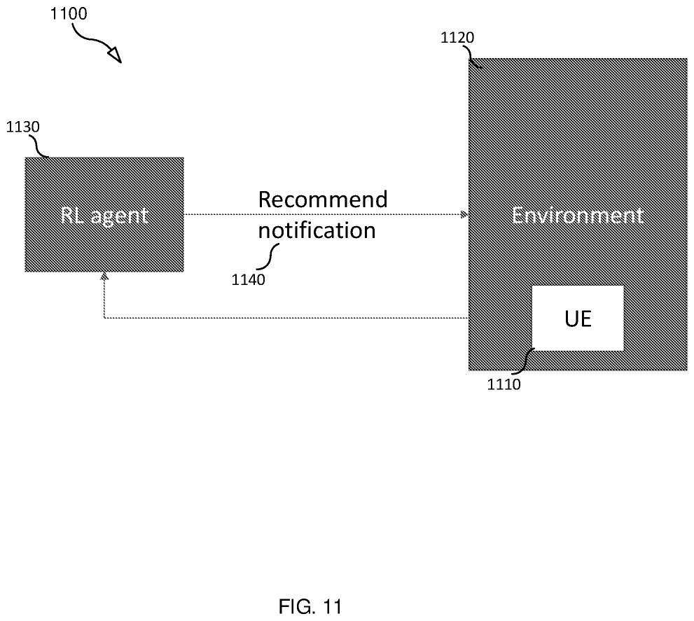

FIG. 11 is a block diagram illustrating an architecture 1100 for a local computing device, UE, or XR user device 1110 in an XR environment 1120, according to some embodiments. This is an alternative to the GNN-based embodiment—which, instead of combining input from multiple users, uses reinforcement learning (RL). This RF-based embodiment includes a personalized RL agent 1130 that is tailored to each specific user and learns appropriate rewards for that user. One advantage of this approach is that it is privacy aware since the user's information never leaves the user's device. Also, since it does not consider input from other users, it is simpler and less computationally expensive.

In an exemplary embodiment, the RL agent 1130 is trained exclusively with input from the user (UE 1110) that is hosting the RL agent 1130 in such a way that it learns to recommend the most appropriate notification for a certain event only for the specific user 1150.

RL models typically include six components: agent, environment, state, reward function, value function and policy. Referring to FIG. 11, the RL agent 1130 is the recommendation engine which takes as input a set of potential notifications 1140. The RL agent 1130 is running within the UE 1110 and the user communicates with it, for example, by touching the smartphone screen depending on the state of the system which is the user's emotional state associated with the potential notifications. The feedback from the user determines the reward. The goal of the agent is to learn a policy that maximizes the reward-most accurately matches the user's new emotional state when showing a certain notification.

State space: The state space includes an array which associates potential notifications with the user's emotional state for a certain event. To ensure that the state space does not grow large, we can consider a buffer of b previous notifications and the user's emotional state to determine the next notification for the upcoming event. (b×10)

Per event type:

| | | | | |
|---|---|---|---|---|
| N₁^{E1} | N₂^{E2} | N₃^{E3} | . . . | N_{N}^{E1} |

| | |
|---|---|
| anger | a1 |
| tense | te1 |
| excited | e1 |
| elated | el1 |
| happy | h1 |
| relaxed | r1 |
| calm | c1 |
| exhausted | ex1 |
| tired | ti1 |
| sad | s1 |

Action space: The action space contains the recommended notification along with the predicted emotional state for the specific event:

| | N₁^{E1′} |
|---|---|
| anger | a1′ |
| tense | te1′ |
| excited | e1′ |
| elated | el1′ |
| happy | h1′ |
| relaxed | r1′ |
| calm | c1′ |
| exhausted | ex1′ |
| tired | ti1′ |
| sad | s1′ |

Rewards: For a reward function we can consider the loss between the predicted emotional state (x′) and the user's emotional state after the notification has been rendered (x):

$$reward = \sqrt{\frac{1}{n} {\sum }_{i}^{N} {x}_{i}^{′ 2} - {x}_{i}^{2}}$$

In this case, the smaller the reward the better the result. Alternatively, instead of matching the next emotional state (xᵢ) we can address a wanted emotional state which can be provided by the user's set of local preferences, as described above in the GNN-based embodiment. We can label that as a wanted state (wᵢ). In this case the reward function can be rewritten as:

$$reward = \sqrt{\frac{1}{n} {\sum }_{i}^{N} {x}_{i}^{′ 2} - {w}_{i}^{2}}$$

x (and w) are vectors that represent the emotional state (anger, tense, excitement, elation, happiness, relaxed, calm, exhaustion, tired, sadness). Every value is normalized within 0 . . . 1. The delta (difference) between the two allows a comparison of them and to instruct the system to favor either the wanted emotional state because of the action, or the next predicted emotional state, which is produced by the environment, again, because of the selected action.

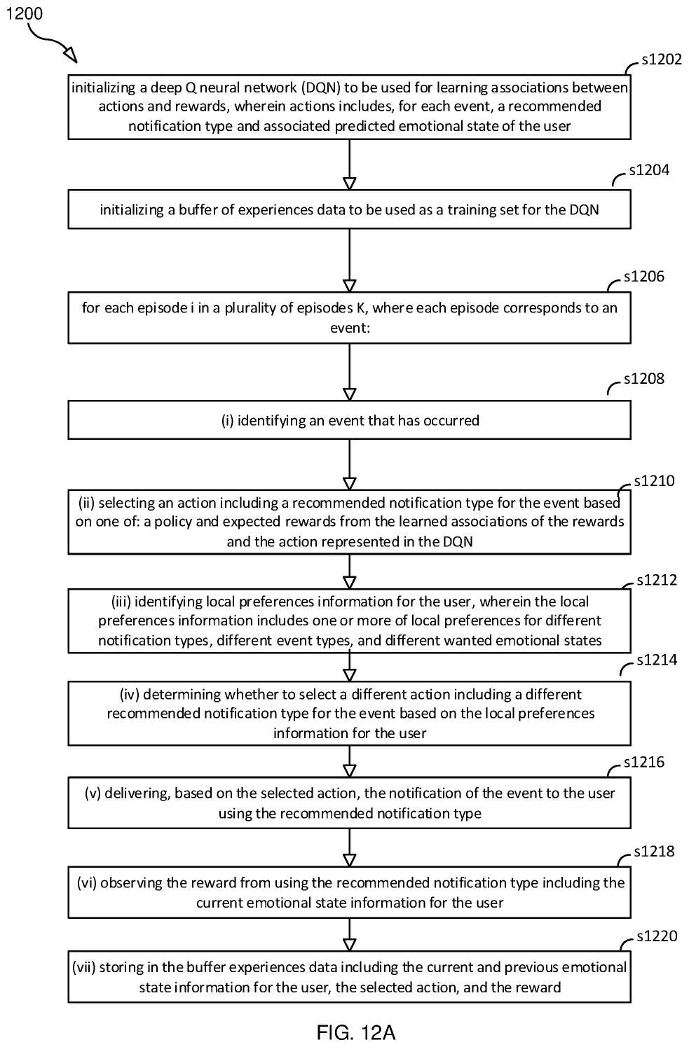

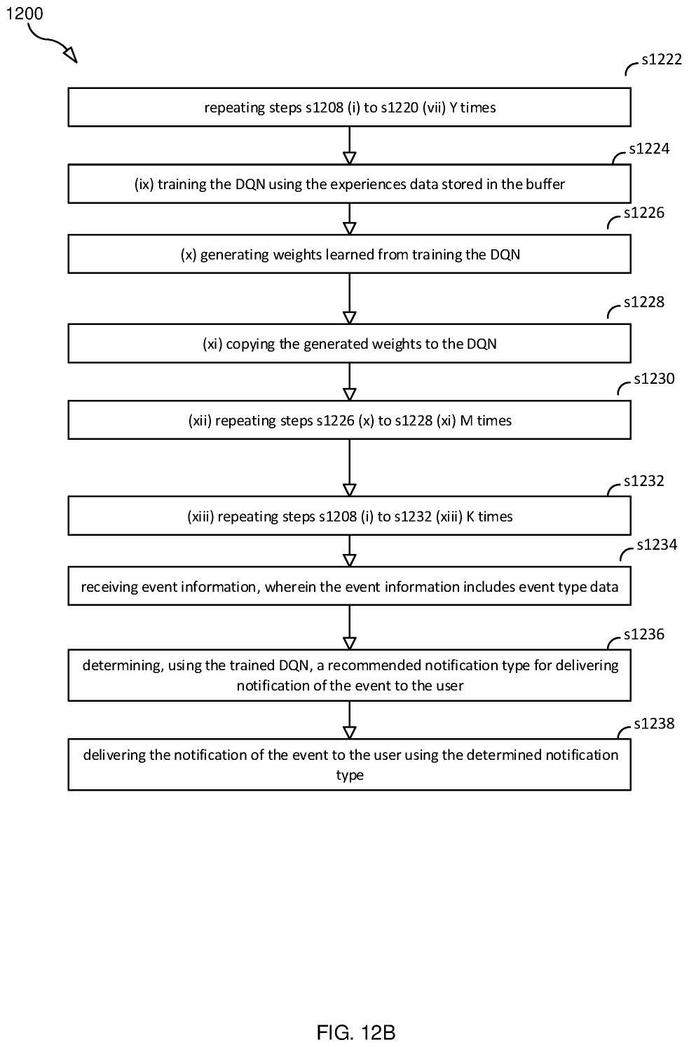

FIG. 12 is a flowchart illustrating a process, according to some embodiments. Process 1200 may begin with step s1202.

Step s1202 comprises initializing a deep Q neural network (DQN) to be used for learning associations between actions and rewards, wherein actions include, for each event, a recommended notification type and associated predicted emotional state of the user.

Step s1204 comprises initializing a buffer of experiences data to be used as a training set for the DQN.

Step s1206 comprises, for each episode i in a plurality of episodes K, where each episode corresponds to an event:

Step s1208 comprises (i) identifying an event that has occurred.

Step s1210 comprises (ii) selecting an action including a recommended notification type for the event based on one of: a policy and expected rewards from the learned associations of the rewards and the action represented in the DQN.

Step s1212 comprises (iii) identifying local preferences information for the user, wherein the local preferences information includes one or more of local preferences for different notification types, different event types, and different wanted emotional states.

Step s1214 comprises (iv) determining whether to select a different action including a different recommended notification type for the event based on the local preferences information for the user.

Step s1216 comprises (v) delivering, based on the selected action, the notification of the event to the user using the recommended notification type.

Step s1218 comprises (vi) observing the reward from using the recommended notification type including the current emotional state information for the user.

Step s1220 comprises (vii) storing in the buffer experiences data including the current and previous emotional state information for the user, the selected action, and the reward.

Step s1222 comprises repeating steps s1208 (i) to s1220 (vii) Y times.

Step s1224 comprises (ix) training the DQN using the experiences data stored in the buffer.

Step s1226 comprises (x) generating weights learned from training the DQN.

Step s1228 comprises (xi) copying the generated weights to the DQN.

Step s1230 comprises (xii) repeating steps s1226 (x) to s1228 (xi) M times.

Step s1232 comprises (xiii) repeating steps s1208 (i) to s1232 (xiii) K times.

Step s1234 comprises receiving event information, wherein the event information includes event type data.

Step s1236 comprises determining, using the trained DQN, a recommended notification type for delivering notification of the event to the user.

Step s1238 comprises delivering the notification of the event to the user using the determined notification type.

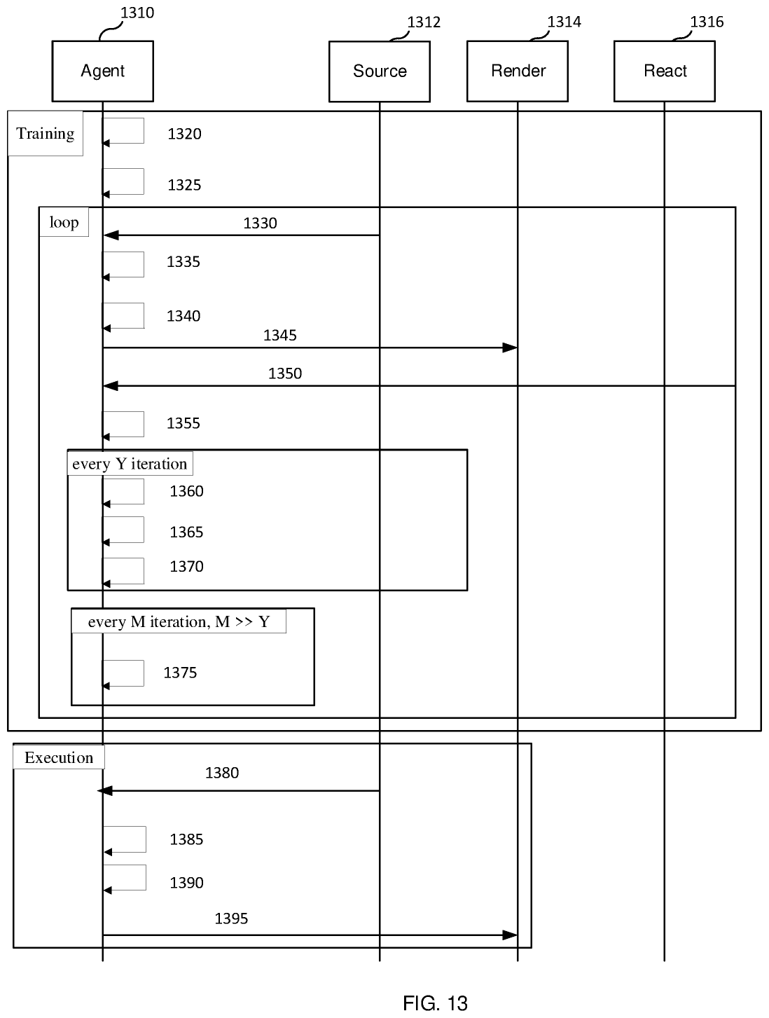

FIG. 13 illustrates a message sequence diagram 1300, according to some embodiments. Agent 1310 is the RL agent. The agent 1310, source 1312, render 1314, and react 1316 are all running within UE 204 or XR user device, as discussed above. Agent 1310 is the recommendation engine, which, as discussed above, in some embodiments is based on unsupervised reinforcement learning (RL). The message sequence diagram 1300 of FIG. 13 illustrates an exemplary sequence flow for training and using the agent 1310 for delivering notifications of events to a user.

Having described the problem as an MDP (Markov Decision process), at step 1320, we initialize a Deep Neural Network (DQN) which will be used for learning the Q-table (association between actions and rewards). Given that the state space for this problem is large, we rely on Q-Learning instead of raw Q-tables.

Training: At 1320-1325, we initialize a buffer of experiences which will be used as a training set for the DQN we initialized previously.

Loop: At 1330-1375, a series of episodes where different events are occurring (produced by the source, e.g., a new email, a notification about weather change and others) and the process learns how to pick an action-what kind of notification type to pick to “render” the event. By render here, we can consider a plurality of representations such as, for example, audio/visual, haptic, taste or smell. An action based on a policy, such as E-greedy, is picked. The action here is a notification type. Initially, a random action is picked, and overtime it will refine its choices based on the different expected rewards that have been learned by this process.

At 1340, the choice of action is refined by taking into consideration local preferences. For example, a user may not want actions (notification types) that are known to cause excitement, so the action will be adapted based on that—e.g., a therefore is adapted to local_a, which will be used as the chosen action afterwards. At 1345, the action (local_a) is reported to the renderer to be represented to the user. This means that the incoming event (notification) will be rendered based on the notification type that has been defined in local_a

At 1350, the process observes the reward that has been achieved from this choice and the new state where the process is now.

At 1355, all this information (the previous state, the current state, the selected action and the reward) are recorded in buffer B to be used later on for training purposes.

Every Y iteration: At 1360-1370, once we have enough experiences in the buffer, we train the DQN. At 1360, this is initialized by randomly selecting a set of samples (mini batches) from the experience buffer. At 1365, we set the Bellman equation which will be used in the gradient descent step. y is known as the (future) discount factor in RL. A low value of y means that the agent is not concerned with delayed reward while a high value would make the agent pick less rewarding actions that might yield high rewards in the future. At 1370, we use the Bellman equation as part of the objective function to train our DQN.

Every M iteration: At 1375, we copy the weights that have been learned in the previous step to the DQN, thus enabling the agent to make new choices based on what it has learned.

Execution: At 1380-1395, an artificial side of the RL process is described-one that does not learn anymore from the environment but instead acts based on what was learned previously. In practice, most RL loops perpetually learn from the environment. In a constrained setup where we do not have such an option, we can just react and use the predictions made by a DQN which we consider to be fully trained. Based on resource availability or other criteria, we oscillate between the training/execution step when we consider that it is time for our system to retrain itself.

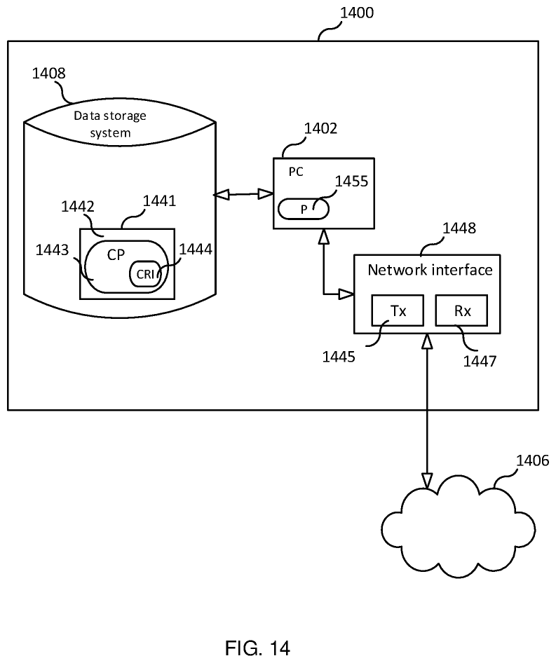

FIG. 14 is a block diagram of an apparatus 1400 according to an embodiment. In some embodiments, apparatus 1400 may be a central computing device 102, a local computing device 104, a user device 204, a UE, or an XR user device, as described above. As shown in FIG. 14, apparatus 1400 may comprise: processing circuitry (PC) 1402, which may include one or more processors (P) 1455 (e.g., one or more general purpose microprocessors and/or one or more other processors, such as an application specific integrated circuit (ASIC), field-programmable gate arrays (FPGAs), and the like); communication circuitry 1448, comprising a transmitter (Tx) 1445 and a receiver (Rx) 1447 for enabling apparatus 1400 to transmit data and receive data (e.g., wirelessly transmit/receive data); and a local storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes device 1400 to perform steps described herein (e.g., steps described herein with reference to the flow charts and sequence diagrams). In other embodiments, device 1400 may be configured to perform steps described herein without the need for code. That is, for example, PC 1402 may consist merely of one or more ASICs. Hence, the features of the embodiments described herein may be implemented in hardware and/or software.

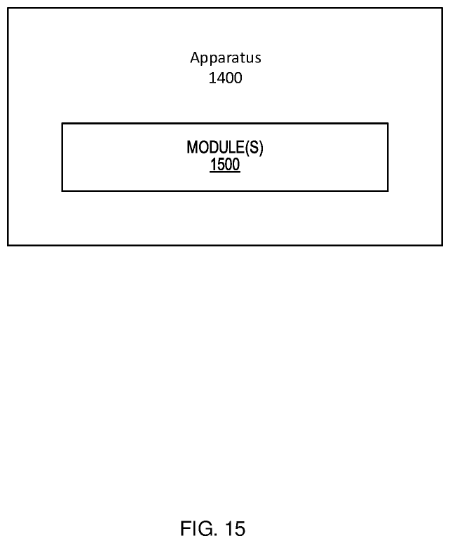

FIG. 15 is a schematic block diagram of the apparatus 1400 according to some other embodiments. The apparatus 1400 includes one or more modules 1500, each of which is implemented in software. The module(s) 1500 provide the functionality of apparatus 1400 described herein and, in particular, the functionality of a central computing device 102, a local computing device 104, a user device 204, a UE, or an XR user device, as described above.

While various embodiments are described herein, it should be understood that they have been presented by way of example only, and not limitation. Thus, the breadth and scope of this disclosure should not be limited by any of the above described exemplary embodiments. Moreover, any combination of the above described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### References

[1] Dzedzickis A, Kaklauskas A, Bucinskas V. Human Emotion Recognition: Review of Sensors and Methods. Sensors (Basel). 2020; 20(3):592. Published 2020 Jan. 21. doi:10.3390/s20030592 (https://www.ncbi.nlm.nih.gov/pmc/articles/PMC7037130/).

[2] Roy Francis Navea et al Stress Detection using Galvanic Skin Response: An Android Application. 2019 J. Phys.: Conf. Ser. 1372 012001 (https://iopscience.iop.org/article/10.1088/1742-6596/1372/1/012001).

[3] Seshadri, D. R., Li, R. T., Voos, J. E. et al. Wearable sensors for monitoring the physiological and biochemical profile of the athlete. npj Digit. Med. 2, 72 (2019) (https://www.nature.com/articles/s41746-019-0150-9).

[4] William L. Hamilton (2020), Graph Representation Learning, Synthesis Lectures on Artificial Intelligence and Machine Learning, Vol. 14, No. 3, Pages 1-159.

1. A computer-implemented method for determining, using a machine learning (ML) model, extended reality (XR) notification types for delivering notification of an event to a user, the method comprising:
receiving user information, wherein the user information includes user characteristics and relationships data;
receiving event information, wherein the event information includes event type data;
determining, using a machine learning (ML) model, recommended notification types for delivering notification of the event to the user and, for each recommended notification type, predicted emotional state information including a predicted emotional state of the user and a rating;
receiving local preferences information for the user, wherein the local preferences information includes one or more of local preferences for different notification types, different event types, and different wanted emotional states;
selecting the notification type for delivering the notification of the event to the user by comparing, for each recommended notification type, the predicted emotional state information and the local preferences information; and
delivering the notification of the event to the user using the selected notification type.

2. The method according to claim 1, wherein the ML model comprises a graph neural network (GNN).

3. The method according to claim 2, further comprising:
collecting data including user information, notification information and context information, wherein the user information includes user characteristics and relationships data, the notification information includes notification types and relationships data, and the context information includes context types and relationships data;
building, using the user characteristics and relationships data, a user-to-user dependency graph representing associations between users;
generating, using the user-to-user dependency graph, first user embeddings;
building, using the context types and relationships data and the notification types and relationships data, a context-to-notification dependency graph representing associations between contexts and notifications;
generating, using the context-to-notification dependency graph, first notification embeddings and context embeddings;
building, using the first notification embeddings and the first user embeddings, a notification-to-user dependency graph representing associations between users and notifications;
generating, using the notification-to-user dependency graph, second notification embeddings and second user embeddings;
combining the generated first and second user embeddings, first and second notification embeddings and context embeddings; and
training the GNN using the combined embeddings to predict recommended notification types for delivering notifications of events to users and, for each recommended notification type for each user, predicted emotional state information including a predicted emotional state of the user and a rating.

4. The method according to claim 3, further comprising:
receiving user rating information for the notification delivered to the user, wherein the user rating information includes actual emotional state information for the user; and
using the received user rating information for retraining the GNN.

5. The method according to claim 1, wherein the user characteristics and relationships data includes one or more of: age, gender, education, interests, friend status, and social networks status.

6. The method according to claim 1, wherein the notification types and relationships data includes one or more of: visual, auditory, tactile, smell, taste, and receiving device type.

7. The method according to claim 1, wherein the context types and relationships data includes one or more of: alarm, meeting, weather change, advertisement, activity type, indoor, outdoor, spatial information, physical distance, and geographical location.

8. The method according to claim 1, wherein the event type data includes one or more of: alarm, weather change, new email, new voicemail, new message, news, announcement, and advertisement.

9. The method according to claim 1, wherein the emotional state of the user corresponds to one or more of: angry, tense, excited, elated, happy, relaxed, calm, exhausted, tired, sad, a measure of valence, and a measure of arousal.

10. The method according to claim 1, wherein the local preferences information for the user is based on one or more of: different levels of attentiveness the user is experiencing and different emotional states of the user that the user has deprioritized.

11. The method according to claim 1, wherein selecting the notification type for delivering the notification of the event to the user by comparing, for each recommended notification type, the predicted emotional state information and the local preferences information comprises:
selecting the notification type with the highest rating.

12. The method according to claim 1, wherein selecting the notification type for delivering the notification of the event to the user by comparing, for each recommended notification type, the predicted emotional state information and the local preferences information comprises:
comparing, for each recommended notification type, the predicted emotional state information and the local preferences information using cosine similarity according to:
$$similarity = \frac{A * B}{‖ A ‖ * ‖ B ‖}$$
and
selecting the notification type that is most similar to the local preferences information.

13. The method according to claim 3, wherein each user, each notification type, and each context type correspond to a node and each of the user characteristics and relationship data, each of the notification types and relationship data, and each of the context types and relationship data correspond to a set of features for each node, and
training the GNN using the combined embeddings comprises:
applying a linear transformation to the features for each node; and
aggregating the features only for the nodes that are related.

14. The method according to claim 13, wherein applying the linear transformation to the features for each node and aggregating the features only for the nodes that are related corresponds to a multilayer perceptron (MLP).

15. A central computing device for determining, using a machine learning (ML) model, extended reality (XR) notification types for delivering notification of an event to a user, comprising:
a memory; and
processing circuitry coupled to the memory, wherein the processing circuitry is configured to:
receive user information, wherein the user information includes user characteristics and relationships data;
receive event information, wherein the event information includes event type data;
determine, using a machine learning (ML) model, recommended notification types for delivering notification of the event to the user and, for each recommended notification type, predicted emotional state information including a predicted emotional state of the user and a rating;
receive local preferences information for the user, wherein the local preferences information includes one or more of local preferences for different notification types, different event types, and different wanted emotional states;
select the notification type for delivering the notification of the event to the user by comparing, for each recommended notification type, the predicted emotional state information and the local preferences information; and
deliver the notification of the event to the user using the selected notification type.

16.-28. (canceled)

29. A computer program product comprising a non-transitory computer readable medium storing a computer program comprising instructions which, when executed by processing circuity of a device, causes the device to perform the method of claim 1.

30. (canceled)

31. A computer-implemented method for determining, using unsupervised reinforcement machine (RL), extended reality (XR) notification types for delivering notifications of events to a user, the method comprising:
initializing a deep Q neural network (DQN) to be used for learning associations between actions and rewards, wherein actions includes, for each event, a recommended notification type and associated predicted emotional state of the user;
initializing a buffer of experiences data to be used as a training set for the DQN;
for each episode i in a plurality of episodes K, wherein each episode corresponds to an event:
(i) identifying an event that has occurred;
(ii) selecting an action including a recommended notification type for the event based on one of: a policy and expected rewards from the learned associations of the rewards and the action represented in the DQN;
(iii) identifying local preferences information for the user, wherein the local preferences information includes one or more of local preferences for different notification types, different event types, and different wanted emotional states;
(iv) determining whether to select a different action including a different recommended notification type for the event based on the local preferences information for the user;
(v) delivering, based on the selected action, the notification of the event to the user using the recommended notification type;
(vi) observing the reward from using the recommended notification type including the current emotional state information for the user;
(vii) storing in the buffer experiences data including the current and previous emotional state information for the user, the selected action, and the reward;
(viii) repeating steps (i) to (vii) Y times;
(ix) training the DQN using the experiences data stored in the buffer;
(x) generating weights learned from training the DQN;
(xi) copying the generated weights to the DQN;
(xii) repeating steps (x) to (xi) M times; and
(xiii) repeating steps (i) to (xiii) K times;
receiving event information, wherein the event information includes event type data;
determining, using the trained DQN, a recommended notification type for delivering notification of the event to the user; and
delivering the notification of the event to the user using the determined notification type.

32.-34. (canceled)

35. A user device for determining, using unsupervised reinforcement machine (RL), extended reality (XR) notification types for delivering notifications of events to a user, comprising:
a memory; and
a processor coupled to the memory, wherein the processor is configured to:
initialize a deep Q neural network (DQN) to be used for learning associations between actions and rewards, wherein actions includes, for each event, a recommended notification type and associated predicted emotional state of the user;
initialize a buffer of experiences data to be used as a training set for the DQN;
for each episode i in a plurality of episodes K, wherein each episode corresponds to an event:
(i) identify an event that has occurred;
(ii) select an action including a recommended notification type for the event based on one of: a policy and expected rewards from the learned associations of the rewards and the action represented in the DQN;
(iii) identify local preferences information for the user, wherein the local preferences information includes one or more of local preferences for different notification types, different event types, and different wanted emotional states;
(iv) determine whether to select a different action including a different recommended notification type for the event based on the local preferences information for the user;
(v) deliver, based on the selected action, the notification of the event to the user using the recommended notification type;
(vi) observe the reward from using the recommended notification type including the current emotional state information for the user;
(vii) store in the buffer experiences data including the current and previous emotional state information for the user, the selected action, and the reward;
(viii) repeat steps (i) to (vii) Y times;
(ix) train the DQN using the experiences data stored in the buffer;
(x) generate weights learned from training the DQN;
(xi) copy the generated weights to the DQN;
(xii) repeat steps (x) to (xi) M times; and
(xiii) repeat steps (i) to (xiii) K times;
receive event information, wherein the event information includes event type data;
determine, using the trained DQN, a recommended notification type for delivering notification of the event to the user; and
deliver the notification of the event to the user using the determined notification type.

36. The user device according to claim 35, wherein the event types include one or more of: alarm, weather change, new email, new voicemail, new message, news, announcement, and advertisement.

37.-38. (canceled)

39. A computer program product comprising a non-transitory computer readable medium storing a computer program comprising instructions, which, when executed by processing circuity of a device causes the device to perform the method of claim 31.

40. (canceled)
